(19) United States
(12) Patent Application Publication
(10) Pub. No.: US 2008/0230604 A1
(43) Pub. Date: Sep. 25, 2008

(54) System for optimizing on-premises advertisements

(76) Inventor: Robert Jason Fong, Toronto (CA)

Correspondence Address: PATENT ADMINISTRATOR;KATTEN MUCHIN ROSENMAN LLP, 2900 K Street NW, Suite 200, WASHINGTON, DC, 20007-5118, US

(21) Appl. No.: 11/726,547

(22) Filed: Mar. 22, 2007

(51) Int. Cl. G06K 15/00

(52) U.S. Cl. 235/383; 705/14

(57) ABSTRACT

A system for optimizing on-premises advertising, for example, at retail food and/or beverage establishments, such as bars, restaurants, night clubs, sports stadiums and other on-premise retail sites. The optimization is based upon on-premise sales data which includes point-of-sale (POS) data and may also take into account waste, spoilage, theft etc (“collectively “native sales data”). In one embodiment of the invention, the system is able to optimize which products are advertised based upon native sales data. In other embodiments of the invention, the system is able to determine the effectiveness of impulse advertisements for the selected products as well as the timing of the impulse advertisements in order to increase sales of selected products and increase the profitability of the retail establishment and improve the return on impulse ad costs.

### BACKGROUND OF THE INVENTION

1. Field of the Invention

The present invention relates to an advertising system and more particularly to an advertising system for optimizing on-premises advertising, for example, at a retail establishment, such as retail food and/or beverage establishments, based upon on-premise sales data in which the effectiveness and timing of on-premise advertisements are optimized as a function of on-premise sales data.

2. Description of the Prior Art

Various retail advertising systems are known in the art. Both web-based and on-premise advertising systems are known. US Patent Application Publication Nos. US 2005/0028188 A1 and US 2006/0089880 A1, as well as International Patent Application Publication Nos. WO 99/50775 A1 and WO 01/37183 A1 all relate to on-line advertising systems. More particularly, US Patent Application Publication Nos. US 2005/0028188 A1 and US 2006/0089880 A1 and International Patent Application Publication No. WO 01/37183 A1 relate to systems for measuring the effectiveness of an on-line advertisement based upon on-line purchase information. International Patent Application Publication Nos. WO 99/50775 A1 relates to an on-line advertising system that targets users based upon user demographics. While such systems may be effective with respect to on-line advertisements, these systems have no applicability to on-premise advertising systems.

U.S. Pat. No. 6,647,269 relates to a system for determining the effectiveness of advertising content delivered to a user's cell phone. The effectiveness of the advertisement is determined by using the user's location, utilizing the user's GPS cell phone data to determine if the user entered the business referred to in the advertisement. Point of sale (POS) data is used to determine if the user makes a purchase within a reasonable time frame. This advertising system disclosed in this system has no applicability to on-premise advertising systems.

US Patent Application Publication Nos. US 2003/0149623 A1 and US 2003/0163359 A1 relate to on-premise advertising systems that require pre-registration by the customer. More particularly, US Patent Application Publication No. US 2003/0149623 A1 discloses a system for monitoring the effectiveness of advertisements. In this system, customers are encouraged to sign up for “saver cards”. Such saver cards specifically identify a customer and may include a magnetic strip, bar code to identify the customer. An example of such a saver card is a Jewel “Preferred Customer” card. Advertisements are sent to customers who sign up for the saver card. The customers use their “saver card” when making a purchase so that POS data is registered with the customer making the purchase. The effectiveness of the advertisements is measured by comparing POS data for the specific customer with the advertisements sent by the retailer via “Internet web site connection, e-mail, telephone, or regular mail.” The advertisements are sent to the potential customers outside of the retail establishment and thus are not well correlated in time with the POS data. As such, the system disclosed in this publication would not be effective in predicting the timing of an advertisement. In addition; “saver cards” are not appropriate and are not used in certain retail establishments, such as bars. Moreover, the system is not effective for customers without saver cards. As such, the system only has limited utility.

US Patent Application Publication No. US 2003/0163359 A1 discloses a system for measuring the effectiveness of advertisements based upon POS data for “registered” users. In this system, user's can register by cell phone by providing their name, credit card company and account number. This information is sent to the system by cell phone or by email, and stored along with the user's cellular phone number as part of the registration process. The system utilizes Global Positioning System (GPS) data, available from the user's cell phone, to provide advertisements via cell phone based upon the user's purchase history and their current location. The system tracks POS data for individual user's by tracking their credit card purchases and compares it with the advertisements. This system only has limited utility, as discussed above. Moreover, users are relatively unlikely to provide credit card information by email and allow a third party to track their purchase history.

US Patent Application Publication Nos. US 2004/0177004 A1 discloses an on-premise advertising and menu display system that can “adjusted” to increase performance based upon transaction time, item selection and profitability. The on-premise advertising and menu display system is an integrated system for a fast food restaurant that has limited menu items and an integrated display for displaying menu items and advertisements on the same display. The system automatically changes the menu items and corresponding advertisements based upon the time of day. For example, breakfast menu items are displayed during morning hours while lunch and dinner menu items are displayed alternatively.

The system also discloses the use of point-of-sale (POS) data to adaptively “adjust” a display based upon the profitability of one or more menu items. Although the system discloses a method for adjusting on-premise menu/advertisement displays, the system only provides a gross correlation between the on-premise menu/advertisement displays and POS data. More particularly, the effectiveness of a display which has both menu items and may contain one or more ads is determined solely on the POS data of the menu item(s) without regard to any ads that may occupy a portion of the display. As such, the system is unable to determine the effectiveness of an ad on the display.

The system disclosed in the '004 publication is also relatively inaccurate since POS data can be extremely inaccurate when used to determine profitability of a menu item in that the determination does not include losses due to waste, spoliation, theft, etc. along with the POS data to determine the net profitability of menu items. Net sales data is known to be known to be 30-40% less than the POS sales data.

In addition, the '004 publication discloses that the system can adjust the advertisement/menu display based upon transaction times. In this system the time of that a particular combination advertisement/menu display is displayed is based on historical data for the menu items being displayed as determined from POS data without consideration of any advertisements on the combination advertisement/menu display. The system is unable to determine the effectiveness of the advertisements or the optimal times to display the advertisements to increase sales. Thus, there is a need to provide a system to determine the effectiveness of advertisements and timing of such advertisements to increase sales of selected products and thus increase profitability of the establishment.

### SUMMARY OF THE INVENTION

The present invention relates in general to a system for optimizing on-premises advertising, for example, at retail food and/or beverage establishments, such as bars, restaurants, night clubs, sports stadiums and other on-premise retail sites, based upon on-premise sales data which includes point-of-sale (POS) data and may also take into account waste, spoilage, theft etc (“collectively “native sales data”). In one embodiment of the invention, the system is able to optimize which products are advertised based upon native sales data. In other embodiments-of the invention, the system is able to determine the effectiveness of impulse advertisements for the selected products as well as the timing of the impulse advertisements in order to increase sales of selected products and increase the profitability of the retail establishment and improve the return on impulse ad costs.

### DESCRIPTION OF THE DRAWING

These and other advantages of the present invention will be readily understood with reference to the following specification and attached drawing wherein:

FIG. 1 is a block diagram of a first embodiment of the present invention which utilizes a full screen display for on-premise advertising.

FIG. 2 is a block diagram a second embodiment of the present invention which utilizes a split screen display screen for on-premise advertisement display.

FIG. 3 is an operational diagram for the system in accordance with the present invention.

### DETAILED DESCRIPTION

The present invention relates in general to a system for optimizing on-premises advertising, for example, at retail food and/or beverage establishments, such as bars, restaurants, night clubs, sports stadiums and other on-premise retail sites, based upon on-premise sales data which includes point-of-sale (POS) data and may also take into account waste, spoilage, theft etc (“collectively “native sales data”). In one embodiment of the invention, the system is able to optimize which products are advertised based upon native sales data. In other embodiments of the invention, the system is able to determine the effectiveness of impulse advertisements for the selected products as well as the timing of the impulse advertisements in order to increase sales of selected products and increase the profitability of the retail establishment and improve the return on impulse ad costs.

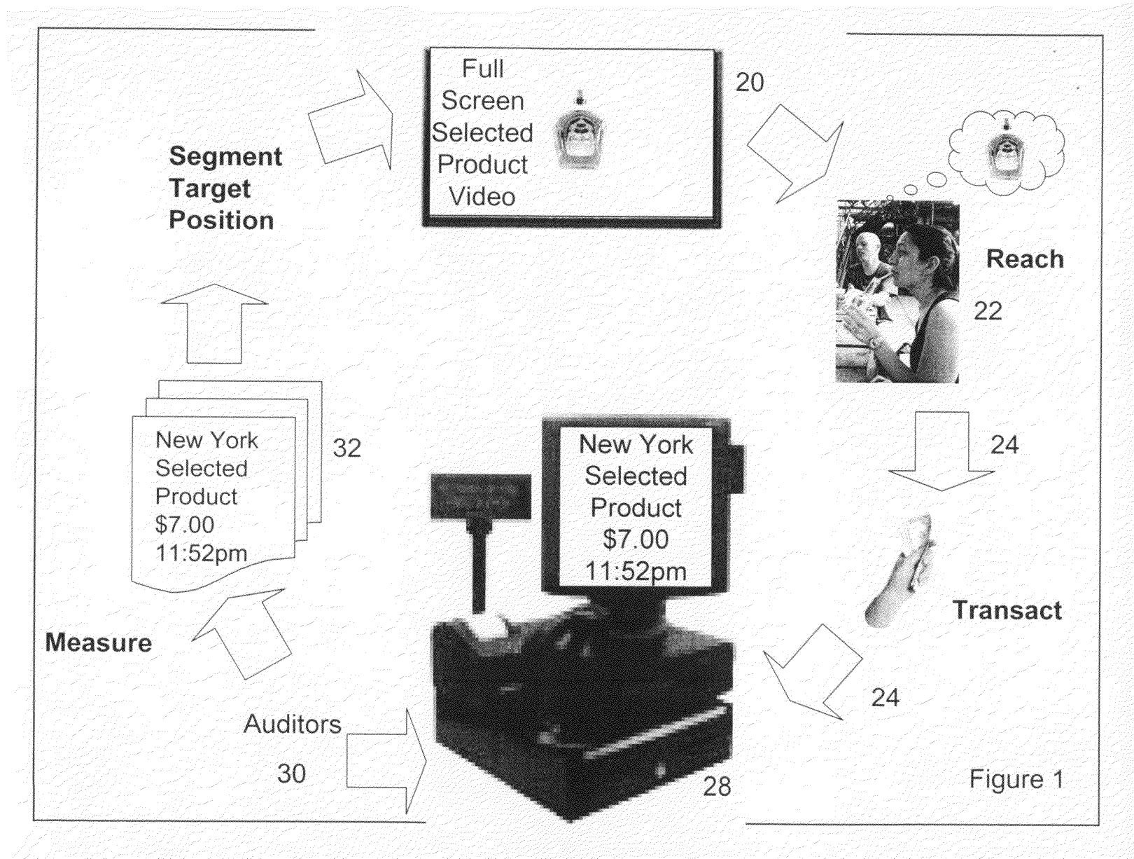

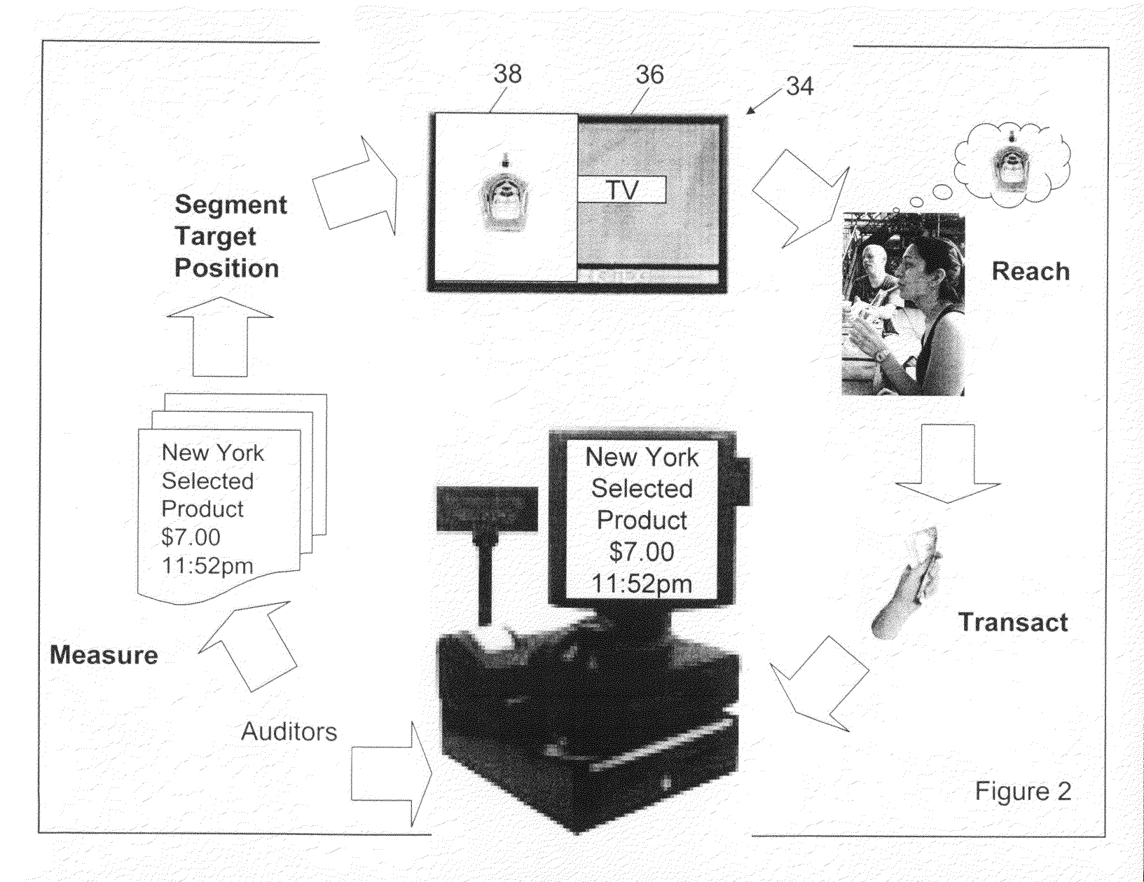

Multiple embodiments of the invention are contemplated. Both embodiments are based upon on-premises advertising. In one embodiment of the invention, as illustrated in FIG. 1, the advertisements are broadcast on full screen displays. Another embodiment of the invention, illustrated in FIG. 2, utilizes a split screen display.

Both embodiments of the invention can be used to display virtually any broadband content. For example, in the embodiment with the full screen display, illustrated in FIG. 1, web-based content, such as, impulse advertisements can be displayed. In the embodiment, illustrated in FIG. 2 in which the display is split between two or more portions, television can be displayed on one portion of the display while other content, such as web-based content can be displayed on one or more of the remaining portions of the display.

In both embodiments of the invention mentioned above, the displays can be configured to display the same content at the same time and be viewable by all of the patrons in the establishment. Alternatively, the displays can be positioned to target specific groups of patrons in a retail establishment and display, for example, different impulse advertisements to the different target groups. For example, in a retail establishment with a restaurant and separate bar, one or more displays are positioned to be viewable by the bar patrons and one or more displays are positioned to be viewable by the restaurant patrons. In such an embodiment, different impulse ads are displayed for the bar and restaurant patrons.

In accordance with an important aspect of the invention, the objective of the invention is to analyze current on-premise advertising campaigns and to optimize future advertisements to maximize the profitability of the establishment. In one embodiment of the invention, historical sales data for one or more products is analyzed for a predetermined trial period, for example, 3 months to establish baseline data. In accordance with an important aspect of the present invention, the baseline data may be based on native sales data, which includes POS data and also takes into account waste, spoilage, theft etc. As mentioned above, POS data is relatively inaccurate and can be off by as much as 30-40%.

The present invention is described and illustrated in connection with impulse ads, for example, web-based ads. However, the principles of the invention are applicable to virtually any digital content, irrespective of whether it is web based. In addition, the principles of the invention are described and illustrated in connection with digital content that is segregated from other broadcast content, such as TV content. The principles of the present invention are also applicable to content that is overlaid over other content, such as broadcast content. Systems for overlaying content on a display are extremely well known in the art. Examples of such systems are disclosed in U.S. Pat. Nos. 5,764,242; 5,883,610; 6,621,499; 6,774,918 and 7,168,087, all hereby incorporated by reference. The process of over-laying an image onto an existing display of broadcast content can also be created entirely by software, as described U.S. Pat. No. 5,903,261, hereby incorporated by reference and briefly described below.

The baseline data for several products available at the retail establishment can be compared to determine the relative profitability of the products on a product by product basis. More specifically, the net profitability based upon the respective native sales data for several products can be compared to determine the one or more products with the highest net profitability. This information can be used to determine which products to use for impulse advertising to increase sales, defined herein as “selected products”. Once the products are selected, the system is able to optimize the effectiveness of the impulse advertisement and optimal timing of the impulse advertisement.

FIG. 1 illustrates a first embodiment of the invention. In this embodiment, one or more full screen video displays, generally identified with the reference numeral 20, are located on premises. A content feed, for example, a web content feed, from a web server (not shown),; an uploaded file plus a schedule of play content, or a content provider may be used to drive the display. As shown, an impulse advertisement for a selected product is displayed in viewing range of patrons of the establishment, as indicated by the box 22. As will be discussed in more detail below, the impulse advertisement is shown at certain times of the day on certain days of the week, herein defined as the advertising period. Sales of the selected product are recorded as POS data, as indicated by the arrows 24 and 26, for example, by a cash register 28.As shown in FIG. 1, the cash register 28 not only records the selected products that are sold but also the price charged for the selected product and the time of the sale. All of this data is typically stored on a back office server.

In accordance with one embodiment of the invention, auditors, as generally indicated by the reference numeral 30, perform an on-premise inventory of the products to determine the amount of loss or shrinkage of all of the products including the selected product. The amount of product purchased by the establishment minus the amount of product sold equals the shrinkage. The shrinkage data is combined with POS data to generate “native sales data”. For example, native sales data can be determined through the use of scales, scanners and computerized equipment to weigh the contents of opened products to determine the actual usage of liquid or solid per bottle or container. This data is the “shrinkage” and is added to the POS sales data to determine the actual or “net” sales..

The shrinkage may result from spoliation, theft or waste or a combination thereof. The auditors are then able to determine the net profitability of each of the products being analyzed. This native sales data is used to select content, i.e. impulse ads, to be broadcast on the display as well as the timing of the broadcast.

Various embodiments of the invention are contemplated. These embodiments include embodiments in which the POS sales data is matched physically or through software with the timing of the broadcast with or without the use of the native data.

Traditionally the cost of content, such as internet content, is based upon the cost per thousand (CPM) or cost per impression advertising data models, for example, as set forth by the well known Nielsen Company. In other words, the cost to the owner of the establishment brand manufacturer or product distributor for display of the impulse ads on the display is normally based on CPM and cost per impression, as indicated by the boxes, generally identified with the reference numeral 32. As such, the number of viewers of the content at a particular time can be estimated by the CPM at a given time. Unfortunately, the traditional data models that are used to determine the cost for content including impulse ads are unable to determine the percentage of those consumers which purchase products displayed in an impulse ad or whether there are specific times of the day that purchasers are more likely to purchase selected products.

The present invention solves this problem by examining POS data or native data after impulse ads are displayed on the display 20. In particular, the system analyzes POS data during which and immediately after, for example, a predetermined number of seconds, minutes, hours, days, weeks, months, quarters and/or years in differing time zones and differing configurations depending on the needs of the advertising campaign. In particular, an impulse ad is displayed to determine what products were purchased and the time of the purchases. This data is compared with the time(s) that the impulse ads were displayed and the specific products featured in the impulse ads to determine the purchase trends during and/or following the advertising period of the selected product. This information is used to determine the effectiveness of the impulse ad and also whether certain times for displaying the impulse ad are better than others. For example, assume the exemplary impulse ad illustrated in FIG. 1 resulted in a 3% upward gain in sales of the product relative to baseline data when displayed before lunch but a 15% gain when displayed after 8:00 pm. The system would thus indicate not only that the impulse ad was effective to increase sales and thus profitability but also that certain advertising periods are better than others. In this scenario, the cost for the content (based on CPM) would likely be the same whether the content was displayed before lunch or after 8:00 pm. However, by displaying the content, i.e. impulse ad, after 8:00 pm in the above scenario, the return on impulse ad (ROIA) would be much higher than the ROIA associated with display of the content before noon. As such, the system in accordance with the present invention is able to improve the profitability of an establishment by improving the ROIA for impulse ads.

FIG. 2 is similar to FIG. 1, except the display, generally identified with the reference numeral 34 is a split screen display, split into two or more portions. As shown, the exemplary display is shown with two portions 36 and 38. One portion 36 may be for displaying television, for example from a cable or satellite content provider, while the other portion 38, may be used for displaying impulse ads, for example from a web server or content provider.

Various techniques are known in the art for driving a split screen display, as described below, all hereby incorporated by reference. For example, US Patent Application Publication No. US 2004/0150751 A1 discloses a system for providing Picture-in-Picture (P-I-P) capabilities in a video display that does not contain 2 tuners US Patent Application Publication No. US 2004/0261106 A1 discloses a display system which includes a set top box 14 and includes a pair of tuners for concurrently displaying video signals, such as TV signals and Internet content, from the tuners in separate viewing areas on a display. U.S. Pat. No. 7,051,351 discloses a system for down loading information from an Internet browser 356 and displaying that information on a display device The information is overlaid on a selected area of the display device 320 or the display device may be divided into a split screen. The system allows Internet content to be displayed concurrently with TV. U.S. Pat. No. 7,119,850 discloses a picture-in-picture (P-I-P) system for a TV and includes a pair of tuners that can be used for simultaneous display of a commercial broadcast content and other content.

The use of a display 36 with a P-I-P function eliminates the need for a separate computer or set top box. In such an embodiment, a TV broadcast feed, for example, from a satellite or cable content provider, is fed into one of the video inputs of the display 34 and an impulse ad feed from a web server or web content provider is fed into another one of the video inputs of the display 34.

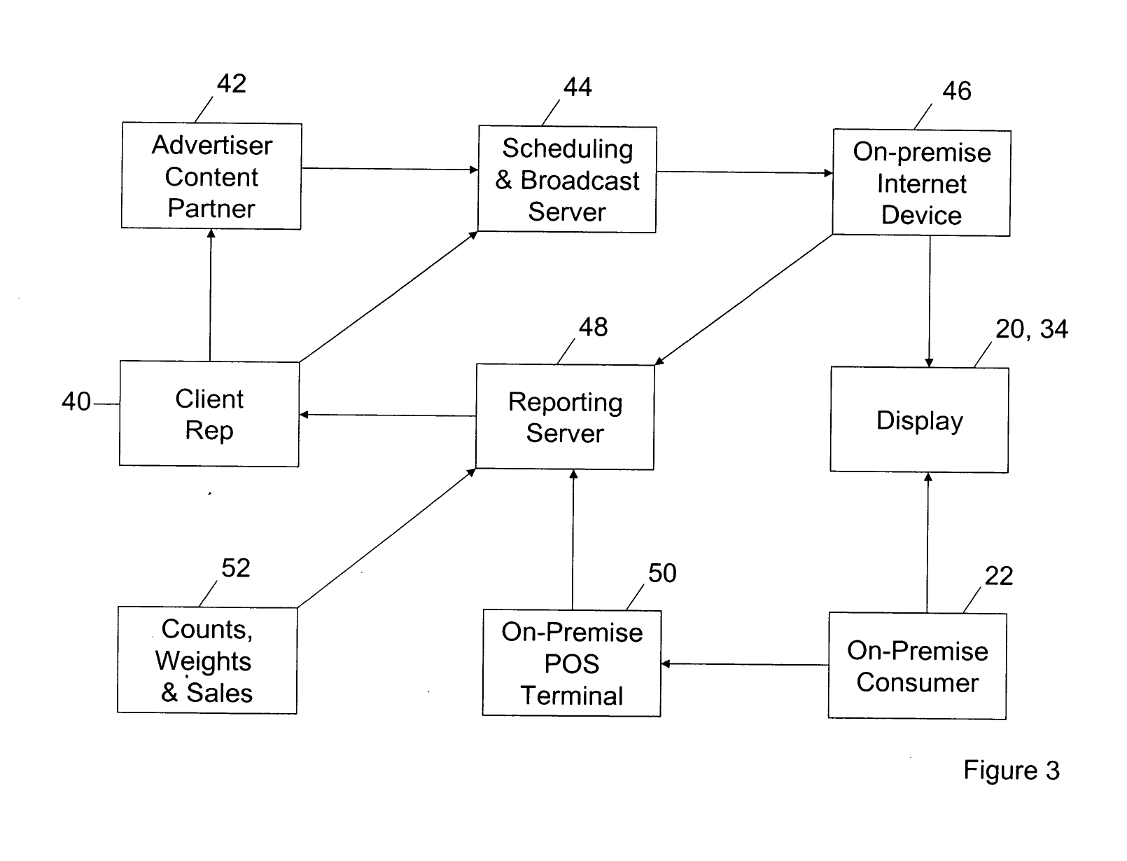

FIG. 3 is a relatively detailed operational diagram for the system in accordance with the present invention. Initially, the owner of the establishment or a representative works with a content provider 42 for impulse ad content. Initial time slots for the impulse ads may be scheduled and loaded into an off-premise scheduling and broadcast server 44 which functions as a web server and also handles scheduling of the impulse ads. The impulse ad content may be electronically transmitted by the content provider 42 directly to the scheduling and broadcast server 44, for example, using File Transfer Protocol (FTP) or other conventional method, such as, by way of a distributed computer system. The server 44 is then responsible for scheduling the broadcast to the displays 20, 34. Alternatively, the impulse ad content can be transmitted to the scheduling and broadcast server 44 by the content provider during the allotted time slot for the specific content. In this case, the scheduling of the broadcast of the impulse ad is handled by the content provider 42 and not the scheduling and broadcast server 44. The time schedule and impulse ad content is uploaded to an on-premise web-based client device 46. The on-premise client device 46 is used to control the displays 20, 34 and specifically controls the broadcast of the impulse ad content. In particular, the on-premise client device 46 controls which impulse ads are displayed and which displays 20, 34 the impulse ads are displayed on. In accordance with an important aspect of the invention, the on-premise client device 46 controls the times or advertising periods in which the impulse ads are displayed.

A reporting server 48 may be provided. The reporting server 48 may be used to track when the impulse ads are properly displayed on the displays 20, 34. There are various methods for determining whether an advertisement has been displayed. One exemplary method is disclosed in International Publication No. WO 01/22792 A2, hereby incorporated by reference. Another exemplary method is described below. More particularly, as mentioned above, in one exemplary method, the on-premise client device 44 (FIG. 3) controls the broadcasting of the display on the on-premise displays 20, 34. In this embodiment, every time an advertisement is displayed, the on-premise client device 44 is configured to log the date and time of the broadcast. Similarly, if the on-premise client device 44 is off-line, the date and times that the on-premise client device 44 is off-line is also logged, for example by the Scheduling and Broadcast Server 44. The log of the times and dates of the display times can be maintained on either the on-premise client device 44 or the reporting server 48.

Purchases of items including items featured in impulse ads by on-premise consumers are time stamped and stored as POS data by date and location by way of an on-premise POS terminal 50. The POS data is transmitted to the reporting server 48 Native data, as discussed above and indicated by the box 52 may also be transmitted to the reporting server 48. The reporting server 48 includes a processor which utilizes the impulse ad scheduling data along with verification that the impulse ad was broadcast from the on-premise client device 46 and the POS data from the on-premise POS Terminal 50 to determine the effectiveness of the impulse ads as well as the optimal times for displaying the impulse ads.

The optimal time for an impulse ad may be determined by displaying the impulse ad at different times during the data and comparing the POS data for the product depicted in the impulse ad for the different advertising periods during which the impulse ad was broadcast. The advertising periods with the highest gains in sales relative to baseline data are determined to be the optimal time slots which provide the greatest ROIA. This determination may then be used to adjust the time slots or advertising periods initially scheduled by the scheduling and broadcast server 44.

In an embodiment based upon video over-lays, various types of overlays are contemplated. For example, on the split screen display with P-I-P functionality, video content could be created to simulate a Bacardi Bat flying from the ad content screen 38 (FIG. 2) to the other screen 36 driven by a TV feed. Another example the system can be configured to simulate a baseball flying at the viewer during a baseball game and look like it originated from the television feed screen 36.

In such an embodiment, the over-lays may be created in software and stored in the Scheduling and Broadcast Server 44 along with scheduling information. The over-lay data and the scheduling data is transmitted to the on premise client device 46 which causes the over-lay to be displayed with the broadcast content. As is known in the art, an image can be controlled remotely through the web by software by adding additional information to content that is already being displayed or will be played according to the schedule. As such, the over-lay image can be programmed to move on top of an existing broadcast TV image or existing split screen ads because the software simply adds on top of the existing information to be displayed at times that are scheduled in a manner, as is known in the art.

In this embodiment, the ad content file is updated the same way as described above by having the content provider 42 (FIG. 3) send the over-lay file/schedule to the Scheduling and Broadcast Server 44 server and/or directly to the on-premise client device 46. The over-lay file could be live or may be already stored in the on-premise client device 46 from a previous uploaded file. If it is live, the file is uploaded to the on-premise client-device and an associated schedule is uploaded at the same time indicating this image/video/etc. will play at the same time as either an ad or either live TV. If the over-lay file is already stored on the on-premise client device 46,, the file just sits there waiting for a schedule to be modified.

Obviously, many modifications and variations of the present invention are possible in light of the above teachings. Thus, it is to be understood that, within the scope of the appended claims, the invention may be practiced otherwise than as specifically described above.

What is claimed and desired to be secured by a Letters Patent of the United States is:

1. A method for optimizing advertisements at a retail establishment, the method comprising the steps of:
(a) displaying one or more impulse ads, messaging or educational content; and
(b) determining the effectiveness of an impulse ad as a function of point of sale (POS) data during or immediately after the impulse ad is broadcast.

2. The method as recited in claim 1, further including the steps of displaying an impulse ad for a selected product during different time slots in a day and comparing the POS data for said different time slots to determine the most effective time slot for increasing sales of the selected product.

3. The method as recited in claim 1, wherein step (b) comprises determining the effectiveness of an impulse ad as a function of native data during or immediately after the impulse ad is broadcast.

4. The method as recited in claim 1, wherein step (a) comprises displaying one or more impulse ads on one or more full screen displays.

5. The method as recited in claim 1, wherein step (a) comprises displaying one or more impulse ads on one or more split-screen displays.

6. The method as recited in claim 5, wherein step (a) comprises displaying one or more impulse ads on one or more split-screen displays which include picture-in-picture functionality.

7. The method as recited in claim 1, wherein step (a) comprises displaying only one impulse ad at a time on all on-premise displays.

8. The method as recited in claim 1, wherein step (a) comprises displaying more than one impulse ad on different on-premise displays at a time.

9. A method for improving the return on impulse ads comprising the steps of:
(a) purchasing impulse ad content for a selected product for one or more on-premise displays at a given cost; and
(b) determining an optimal time slot for broadcasting the impulse ad content which optimizes sales of the selected product.

10. The method as recited in claim 9, wherein step (b) comprises determining an optimal time slot for broadcasting the impulse ad content which optimizes sales of the selected product by broadcasting the impulse ad content during different time slots and comparing the POS data for the different slots for the selected product to determine the time slots which resulted in the greatest number of sales of the selected product.

11. A system for optimizing advertisements at a retail establishment, the system comprising:
(a) one or more displays for displaying one or more impulse ads; and
(b) a reporting server for determining the effectiveness of an impulse ad as a function of point of sale (POS) data during or immediately after the impulse ad is broadcast.

12. The system as recited in claim 1, further including a client device which causes said impulse ad for a selected product to be broadcast during different time slots in a day and compares the POS data for said different time slots to determine the most effective time slot for increasing sales of the selected product.

13. The system as recited in claim 11, wherein said reporting server is configured to determine the effectiveness of an impulse ad as a function of native data during or immediately after the impulse ad is broadcast.

14. The system as recited in claim 11, wherein at least one of said one or more displays is a full screen display.

15. The system as recited in claim 11, wherein at least one of said one or more displays is a split-screen display.

16. The system as recited in claim 15, wherein said at least one split-screen display includes picture-in-picture functionality.

17. The system as recited in claim 11, wherein said client device is configured to display only one impulse ad at a time on all on-premise displays.

18. The system as recited in claim 11, wherein said client device is configured to display more than one impulse ad on different on-premise displays at a time.

19. A system for improving the return on impulse ads, the system comprising:
(a) a display for displaying impulse ad content for a selected product for one or more on-premise displays; and
(b) a reporting server for determining an optimal time slot for broadcasting the impulse ad content which optimizes sales of the selected product.

20. The system as recited in claim 19, wherein the reporting server is configured to determine an optimal time slot for broadcasting the impulse ad content which optimizes sales of the selected product by broadcasting the impulse ad content during different time slots and comparing the POS data for the different slots for the selected product to determine the time slots which resulted in the greatest number of sales of the selected product.
